(19) United States
(12) Patent Application Publication
(10) Pub. No.: US 2025/0278053 A1
(43) Pub. Date: Sep. 4, 2025

(54) IMAGE FORMING APPARATUS

(71) Applicant: CANON KABUSHIKI KAISHA, Tokyo (JP)

(72) Inventor: HIROMICHI KOSEKI, Saitama (JP)

(21) Appl. No.: 19/062,668

(22) Filed: Feb. 25, 2025

(30) Foreign Application Priority Data
Feb. 29, 2024 (JP) 2024-030718

(51) Int. Cl. G03G 21/16

(52) U.S. Cl. CPC G03G 21/1619; G03G 2221/1684

(57) ABSTRACT

An image forming apparatus configured to form an image on a recording medium includes a first block including a first frame, a transfer member for transferring the image onto the recording medium, and a first conveyance path in which the recording medium is conveyed, a second block including a second frame separably stacked on the first frame, a second conveyance path in which the recording medium is conveyed from the first conveyance path, and a discharging unit configured to discharge the recording medium conveyed through the second conveyance path to an outside, three supporting portions for supporting the first block, and three supporting portions for supporting the second block. The first block is supported via the three supporting portions for supporting the first block. The second block is supported via the three supporting portions for supporting the second block with respect to the first block.

### BACKGROUND OF THE INVENTION

### Field of the Invention

This disclosure relates to an image forming apparatus such as a printer, a copier, a facsimile, or a multifunction machine.

### Description of the Related Art

Hitherto, in image forming apparatuses, a single main frame is constructed by integrating a plurality of sheet metals using screw fastening or welding (see Japanese Patent Laid-Open No. 2021-39153). Then, various units are supported by the single main frame.

### SUMMARY OF THE INVENTION

This disclosure provides an image forming apparatus including a plurality of separable frames.

According to one aspect of the present invention, an image forming apparatus configured to form an image on a recording medium includes a first block including a first frame, a transfer member for transferring the image onto the recording medium, and a first conveyance path in which the recording medium is conveyed, a second block including a second frame separably stacked on the first frame, a second conveyance path in which the recording medium is conveyed from the first conveyance path, and a discharging unit configured to discharge the recording medium conveyed through the second conveyance path to an outside, three supporting portions for supporting the first block, and three supporting portions for supporting the second block. The first block is supported via the three supporting portions for supporting the first block. The second block is supported via the three supporting portions for supporting the second block with respect to the first block.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus.

FIG. 2A is a schematic diagram illustrating a discharging frame.

FIG. 2B is a schematic diagram illustrating an imaging frame.

FIG. 2C is a schematic diagram illustrating a supply frame.

FIG. 3 is a schematic diagram illustrating supporting portions of each block.

FIG. 4 is a schematic diagram illustrating positions of a third supporting portion of the imaging frame, and a connecting strut.

FIG. 5A is a schematic diagram illustrating positional relationships among the supporting portions in a discharging block.

FIG. 5B is a schematic diagram illustrating positional relationships among the supporting portions in an imaging block.

FIG. 5C is a schematic diagram illustrating positional relationships among the supporting portions in a supply block.

### DESCRIPTION OF THE EMBODIMENTS

The present inventors have identified that conventional techniques, involving the assembly of various units and the like into the single main frame, have issues. For example, it is difficult to expand functions of the image forming apparatuses. Sometimes, it is necessary to replace some units of the image forming apparatuses with units that have different functions. However, the conventional single main frames are designed with the premise of supporting specific units. Therefore, in most cases, it is not possible to replace the units with alternative units. In addition, as another example, sometimes, according to diverse requirements from users, it is necessary to provide a plurality of image forming apparatuses with specifications that differ from each other. In cases of the image forming apparatuses that possess the single main frame, the main frame is designed on a zero base for each specification. This is a bottleneck in development, design, and manufacturing.

### First Embodiment

### Image Forming Apparatus

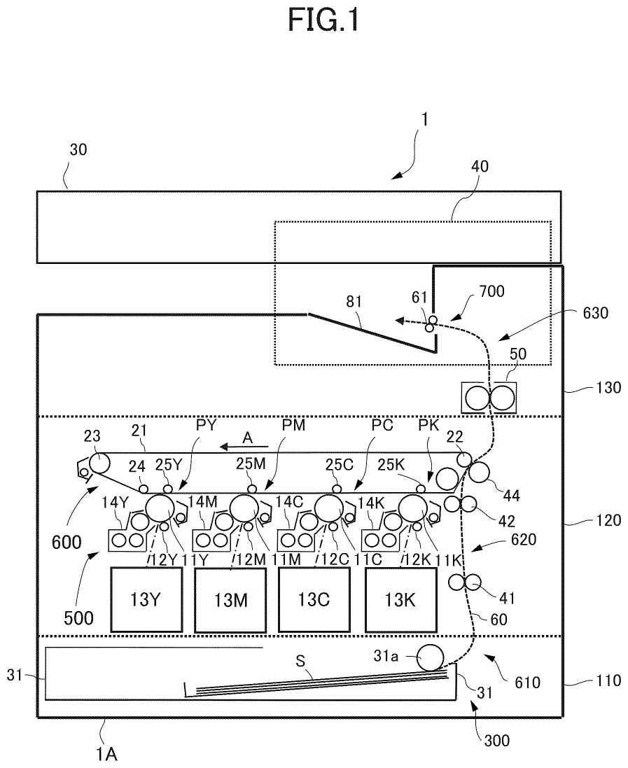

Hereinafter, this embodiment will be described. First, using FIG. 1, a schematic configuration of an image forming apparatus of this embodiment will be described. To be noted, “front” and “rear” used in the following description refer to a front side of the image forming apparatus as the front, and a rear side as the rear. “Right” and “left” correspond to the sides in a case where the apparatus is viewed from the front. The front side is a side on which a user operates the apparatus, and, for example, is a side on which an operation panel is arranged or from which a cassette that stores a recording material is drawn out. “Vertical direction” refers to an upper/lower direction in a state in which the image forming apparatus is installed on an installation surface such as a floor. FIG. 1 illustrates the image forming apparatus 1 as viewed from the front side.

The image forming apparatus 1 illustrated in FIG. 1 is a full color printer of an intermediate transfer system. Image forming units PY, PM, PC, and PK of four colors, which form toner images of yellow (Y), magenta (M), cyan (C), and black (K), are arranged to face an intermediate transfer belt 21. The image forming apparatus 1 includes an image formation unit 500. The image formation unit 500 forms the toner image on a recording material S based on an image signal received from a document reading unit 30, an external device such as a personal computer, not shown, or the like. The image formation unit 500 includes the image forming units PY, PM, PC, and PK and an intermediate transfer unit 600.

While not illustrated, the document reading unit 30 disposed on top of an apparatus body 1A includes an image conveying unit and a document reading unit. The document conveying unit is disposed such that the front side (front face side) can be opened and closed with respect to the image reading unit. The user can stack a document, whose image requires reading, on the document conveying unit. In a closed state, the document conveying unit can automatically convey the document to the image reading unit one sheet of the document at a time. The image reading unit includes a document table and a reading sensor, and reads the image of the document placed on the document table one sheet of the document at a time. To be noted, the user can place the document on the document table with the document conveying unit opened, and can also capture the image of the document with the reading sensor by closing the document conveying unit with the document remaining on the document table.

A conveyance process of the recording material S in the image forming apparatus 1 will be described. The recording material S is stored in a cassette 31, serving as a container, in a stacked manner. The conveyance of the recording material S is started by a supply unit 300, serving as a supply unit. The supply unit 300 includes a supply roller 31a. The recording material S is supplied from the cassette 31 to a conveyance path 60 by the supply roller 31a one sheet at a time in synchronization with the timing for image formation. In the image forming apparatus 1 of this embodiment, the conveyance path 60 can convey the recording material S from below to above (so-called vertical conveyance method). To be noted, the recording material S includes various type of sheet materials, including a paper sheet such as standard paper, thick paper, rough paper, embossed paper, and coated paper, a plastic film, cloth, and the like.

The recording material S supplied from the cassette 31 to the conveyance path 60 is conveyed to a pre-registration roller pair 41 arranged in the middle of the conveyance path 60. The pre-registration roller pair 41 and a registration roller pair 42 correct the skew of the recording material S. In particular, a leading edge of the recording material S conveyed by the pre-registration roller pair 41 abuts against a nip portion of the registration roller pair 42, which is stopping. With the leading edge of the recording material S aligned at a position of the nip portion of the registration roller pair 42, the skew correction is performed by looping or bending the recording material S. Subsequent to performing the skew correction, the registration roller pair 42 starts rotation in synchronization with the timing of secondary transfer, and conveys the recording material S. The intermediate transfer belt 21 and a secondary transfer portion are arranged above the registration roller pair 42, serving as a conveyance rotary member. The registration roller pair 42 conveys the recording material S to the secondary transfer portion from below to above in synchronization with the timing at which the toner image on the intermediate transfer belt 21 is transferred onto the recording material S (timing of secondary transfer). The registration roller pair 42 is arranged at the closest position to the secondary transfer portion on an upstream side of the secondary transfer portion with respect to the conveyance direction (vertical direction) of the recording material S conveyed through the conveyance path 60. The secondary transfer portion is formed by a secondary transfer inner roller 22 and a secondary transfer outer roller 44 with the intermediate transfer belt 21. The secondary transfer inner roller 22 and the secondary transfer outer roller 44 (second transfer member, secondary transfer member) face each other across the intermediate transfer belt 21, serving as a transfer member (first transfer member, intermediate transfer member). The secondary transfer portion (secondary transfer inner and outer rollers 22 and 44) forms a nip portion, and transfers the toner image onto the recording material S by applying a predetermined pressure force and secondary transfer voltage.

With respect to the conveyance process of the recording material S up to the secondary transfer portion described above, an image forming process of the image that is sent to the secondary transfer portion at a similar timing will be described. First, the image forming units PY to PK will be described. However, since the image forming units PY to PK are essentially the same except for the color of the toner, in the following description, the image forming unit PY for yellow will be described as a representative example.

The image forming unit PY includes a photosensitive drum 11Y, serving as a photosensitive member, a charging apparatus 12Y, serving as a charge unit, an exposing apparatus 13Y, serving as an exposing unit, and a developing apparatus 14Y, serving as a developing unit. A surface of the photosensitive drum 11Y that is rotatably driven has been uniformly charged by the charging apparatus 12Y beforehand, and, thereafter, an electrostatic latent image is formed with a laser beam emitted from the exposing apparatus 13Y that is driven based on the image signal. Then, the electrostatic latent image formed on the photosensitive drum 11Y is developed into the toner image by the developing apparatus 14Y. The developing apparatus 14Y develops the electrostatic latent image into the toner image using developer containing the toner and a carrier. To be noted, since the toner is consumed along with the development, at a suitable timing, the toner is replenished from a toner bottle, not shown, which stores the toner for replenishment, to the developing apparatus 14Y.

A primary transfer voltage is applied to the toner image formed on the photosensitive drum 11Y (on the photosensitive member) by a primary transfer roller 25Y, which is arranged to face the photosensitive drum 11Y across the intermediate transfer belt 21, and the toner image is primarily transferred from the photosensitive drum 11Y onto the intermediate transfer belt 21. Primary transfer residual toner that remains on the photosensitive drum 11Y after the primary transfer is collected by a photosensitive drum cleaner.

The intermediate transfer belt 21 is an endless belt that is stretched by the secondary transfer inner roller 22, a drive roller 23, a tension roller 24, and the like, and is moved in an arrow A direction in FIG. 1. That is, the intermediate transfer belt is configured in an annular shape. The tension roller 24 is a driven rotary member, and, while applying tension to the intermediate transfer belt 21, rotates in conjunction with a movement of the intermediate transfer belt 21 that is driven by the drive roller 23. The image forming processes for each color, which are processed in parallel by the image forming units PY to PK described above, are performed at the timing of sequentially superimposing on the toner image of each color primarily transferred upstream in the moving direction on the intermediate transfer belt. As a result, eventually, the toner image of the full color is formed on the intermediate transfer belt 21, and, by the movement of the intermediate transfer belt 21, the toner image is conveyed to the secondary transfer portion. To be noted, in this embodiment, the primary transfer rollers 25Y to 25K, the intermediate transfer belt 21, the secondary transfer inner roller 22, the drive roller 23, and the tension roller 24 are configured integrally as the intermediate transfer unit 600. However, the technology of this disclosure is not limited to such a configuration.

As described above, through the conveyance process and the image forming process each described above, at the secondary transfer portion, the timing of the recording material S and the full color toner image aligns, and the secondary transfer of the toner image from the intermediate transfer belt 21 onto the recording material S is performed. Secondary transfer residual toner that remains on the intermediate transfer belt 21 after passing through the secondary transfer portion is collected from the intermediate transfer belt 21 by a belt cleaner. The recording material S onto which the toner image has been transferred is conveyed to a fixing apparatus 50 through the conveyance path 60, and, by applying heat and pressure in the fixing apparatus 50, the toner image is fixed on the recording material S. The fixing apparatus 50 includes a fixing roller, which is heated by a heater, not shown, and a pressing roller, which forms a fixing nip portion by coming into contact with the fixing roller, and fixes the toner image on the recording material S by applying the heat and pressure to the recording material S that passes through the fixing nip portion. The recording material S on which the toner image has been fixed by the fixing apparatus 50 is conveyed further upward through the conveyance path 60, and is discharged outside by a sheet discharge unit 700, serving as a sheet discharge unit. The sheet discharge unit 700 includes a sheet discharge roller 61, and the recording material S is supported on a sheet discharge tray 81 by being discharged by the sheet discharge roller 61.

In the apparatus body 1A of the image forming apparatus 1, the operation panel 40, which includes a display for displaying various information, keys capable of inputting various information according to user operations, and the like, is arranged to face the front (front face side). The user can adjust various settings at the time of operating the image forming apparatus 1 using the operation panel 40. For example, in a case where the user performs a copy operation, the user can set parameters such as the number of sheets of the recording material S to be printed out, the size of the recording material S to be printed out, the cassette storing the recording material S to be printed out, scaling and density adjustments of a copy image, single-sided/double-sided copying, color/monochrome copying, etc., using the operation panel 40.

### Apparatus Body

Next, the apparatus body 1A of this embodiment will be described. In a case of this embodiment, the apparatus body 1A (structure) is divided into three separable structures: a supply block 110, an imaging block 120, and a discharging block 130. To be noted, in this specification, the term “structure” refers to a state in which various units or components are mounted to a frame formed by members such as a strut and a stay (beam). In other words, the state in which the various units or the components are mounted to the frame is a state in which the various units or the components are supported by the frame. The supply, imaging and discharging blocks 110, 120, and 130 respectively include a supply frame 100e, an imaging frame 100f, and a discharging frame 100g, as described below. For the purpose of making the three structures separable, the supply, imaging, and discharging frames 100e, 100f, and 100g are configured to be separable from each other.

In this embodiment, the apparatus body 1A, which achieves a series of functions for forming the image on the recording material S, is configured such that the imaging block 120 is stacked on top of the supply block 110 and the discharging block 130 is stacked on top of the imaging block 120. While not illustrated, the stacked imaging and discharging blocks 120 and 130 are interconnected by fastening a metallic plate-shaped member (coupling member), which bridges between the struts positioned vertically, using screws. The supply and imaging blocks 110 and 120 are also similarly interconnected with the coupling member.

### Supply, Imaging, and Discharging Blocks

The supply block 110, serving as a third block, is a structure in which the supply unit 300 and a supply conveyance path 610 are assembled into the supply frame 100e, described below. In addition, a rail member, not shown, which slidably supports the cassette 31 in a front-to-rear direction, and the like are assembled into the support block 110. The imaging block 120, serving as a first block, is a structure in which the image formation unit 500 including the intermediate transfer unit 600 and an imaging conveyance path 620 are assembled into the imaging frame 100f, described below. The image formation unit 500 may be detachably disposed in the imaging frame 100f. The discharging block 130, serving as a second block, is a structure in which the sheet discharge unit 700, a discharging conveyance path 630, and the fixing apparatus 50 are assembled into the discharging frame 100g, described below.

In this embodiment, the conveyance path 60 that conveys the recording material S from below to above is divided and formed into each of the supply, imaging, and discharging blocks 110, 120, and 130. That is, the supply conveyance path 610, serving as a third conveyance path, forms part of the conveyance path 60 in the supply block 110, the imaging conveyance path 620, serving as a first conveyance path, forms part of the conveyance path 60 in the imaging block 120, and the discharging conveyance path 630, serving as a second conveyance path, forms part of the conveyance path 60 in the discharging block 130. In the supply conveyance path 610, the recording material S is conveyed from the cassette 31 toward the imaging conveyance path 620, and, in the discharging conveyance path 630, the recording material S is conveyed from the imaging conveyance path 620.

### Discharging, Imaging, and Supply Frames

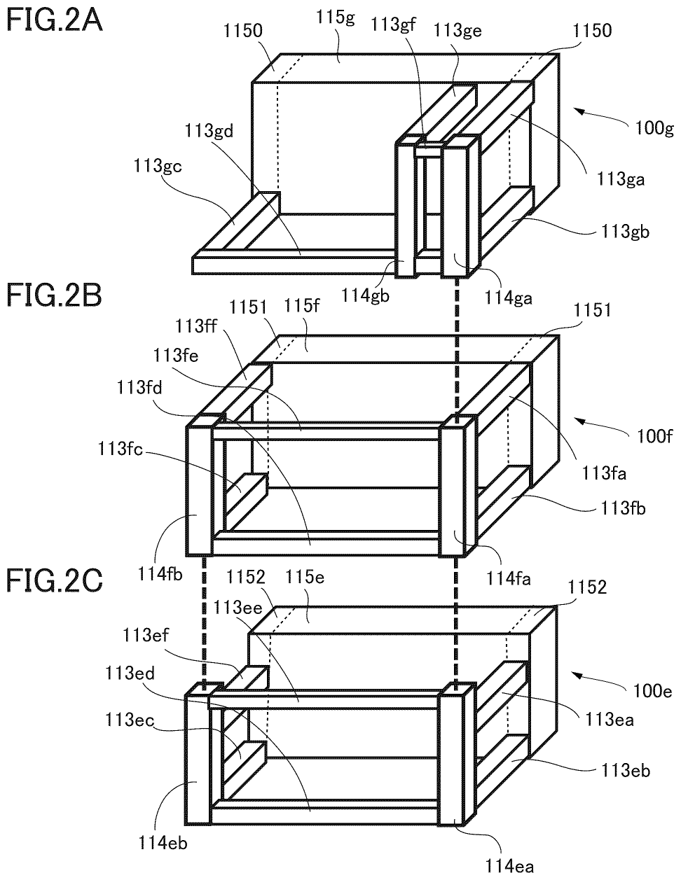

Here, using FIGS. 2A to 2C, the discharging, imaging, and supply frames 100g, 100f, and 100e described above will be described. As illustrated in FIG. 2A, the discharging frame 100g, serving as a second frame, includes a right front strut 114ga, a rear-side plate 115g, a right upper stay 113ga, a right lower stay 113gb, a left stay 113gc, and a front stay 113gd. The right front strut 114ga is extended in the vertical direction. The right upper and lower stays 113ga and 113gb are arranged in the vertical direction with respect to the right front strut 114ga, are arranged substantially parallel to each other, and each connect the right front strut 114ga with the rear-side plate 115g. On the right lower stay 113gb, the left stay 113gc is arranged in a direction substantially perpendicular to the rear-side plate 115g such that the left stay 113gc is arranged substantially parallel and opposite to the right lower stay 113gb. The front stay 113gd is arranged in a direction (lateral direction) parallel to the rear-side plate 115g such that the front stay 113gd connects the left stay 113gc and the right front strut 114ga.

In addition, the discharging frame 100g includes a front strut 114gb, an upper stay 113ge, and a right upper stay 113gf. The right strut 114gb is arranged further to the right than the center of the front stay 113gd is between the left stay 113gc and the right lower stay 113gb in the lateral direction, and is arranged substantially parallel to the right front strut 114ga. The front strut 114gb is connected to the front stay 113gd. The upper stay 113ge is arranged substantially parallel to the right upper stay 113ga such that the upper stay 113ge connects the front strut 114gb and the rear-side plate 115g. The right upper stay 113gf is arranged substantially parallel to the front stay 113gd such that the right upper stay 113gf connects the right front strut 114ga and the front strut 114gb. The discharging unit 700 described above is assembled into a space secured by these struts 114ga and 114gb and stays 113ga, 113gb, 113ge, and 113gf, and the rear-side plate 115g.

As illustrated in FIG. 2B, the imaging frame 100f, serving as a first frame, includes a right front strut 114fa, a left front strut 114fb, a rear-side plate 115f, a right upper stay 113fa, a right lower stay 113fb, a left upper stay 113ff, a left lower stay 113fc, a front upper stay 113fe, and a front lower stay 113fd. The right front strut 114fa is extended in the vertical direction. The right upper and lower stays 113fa and 113fb are arranged in the vertical direction with respect to the right front strut 114fa, are arranged substantially parallel to each other, and each connect the right front strut 114fa and the rear-side plate 115f. The left front strut 114fb is extended in the vertical direction such that the left front strut 114fb is arranged substantially parallel and opposite to the right front strut 114fa. The left upper and lower stays 113ff and 113fc are arranged in the vertical direction with respect to the left front strut 114fb, are arranged substantially parallel to each other, and each connect the left front strut 114fb and the rear-side plate 115f. The front upper stay 113fe is arranged in a direction (lateral direction) parallel to the rear side plate 115f such that the front upper stay 113fe connects the right and left front struts 114fa and 114fb at their upper end portions. The front lower stay 113fd is arranged in the direction (lateral direction) parallel to the rear-side plate 115f, to connect the right and left front struts 114fa and 114fb at their lower end portions. In the imaging frame 100f, to ensure strength as the frame, the right front strut 114fa, the left front strut 114fb, and reinforcement members 1151, which correspond to struts disposed in the rear-side plate 115f, are arranged at four corners of the frame. In the rear-side plate 115f, the reinforcement members 1151 are disposed at both end portions in the lateral direction.

As illustrated in FIG. 2C, the supply frame 100e, serving as a third frame, includes a right front strut 114ea, a left front strut 114eb, a rear-side plate 115e, a right upper stay 113ea, a right lower stay 113eb, a left upper stay 113ef, a left lower stay 113ec, a front upper stay 113ee, and a front lower stay 113ed. The right front strut 114ea is extended in the vertical direction. The right upper and lower stays 113ea and 113eb are arranged in the vertical direction with respect to the right front support column 114ea, are arranged substantially parallel to each other, and each connect the right front strut 114ea and the rear-side plate 115e. The left front strut 114eb is extended in the vertical direction such that the left front strut 114eb is arranged substantially parallel and oppose to the right front strut 114ea. The left upper and lower stays 113ef and 113ec are arranged in the vertical direction with respect to the left front strut 114eb, are arranged substantially parallel to each other, and each connect the left front strut 114eb and the rear-side plate 115e. The front upper stay 113ee is arranged in a direction (lateral direction) parallel to the rear-side plate 115e such that the front upper stay 113ee connects the right and left front struts 114ea and 114eb at their upper end portions. The front lower stay 113ed is arranged in the direction (lateral direction) parallel to the rear-side plate 115e such that the front lower stay 113ed connects the right and left front struts 114ea and 114eb at their lower end portions. To be noted, in the vertical direction, a connecting position of the right upper stay 113ea with respect to the right front strut 114ea and a connecting position of the left upper stay 113ef with respect to the left front strut 114eb are below connecting positions of the front upper stay 113ee with respect to the right and left front struts 114ea and 114eb. In the supply frame 100e, to ensure strength as the frame, the right front strut 114ea, the left front strut 114eb, and reinforcement members 1152, which correspond to struts disposed in the rear-side plate 115e, are arranged at four corners of the frame. In the rear-side plate 115e, the reinforcement members 1152 are disposed at both end portions in the lateral direction.

As described above, the apparatus body 1A can be assembled by dividing it into the supply, imaging, and discharging blocks 110, 120, and 130. The supply frame 100e of the supply block 110 is mounted beneath the imaging frame 100f of the imaging block 120, and can be divided from the imaging frame 100f. The discharging frame 100g of the discharging block 130 is mounted on top of the imaging frame 100f of the imaging block 120, and can be divided from the imaging frame 100f. Thereby, since units and components can be assembled into each of the supply, imaging, and discharging blocks 110, 120, and 130, it is possible to significantly reduce assembly man-hours for the apparatus body 1A, and it is possible to improve the product quality of the apparatus body 1A. Further, since it is straightforward to add and assemble units that achieve new functions (such as, a second fixing apparatus) into the supply, imaging, and discharging frames 100e, 100f, and 100g by dividing the apparatus body 1A into the supply, imaging, and discharging blocks 110, 120, and 130, it is easy to expand the functions of the image forming apparatus 1.

### Supporting Configuration of Block

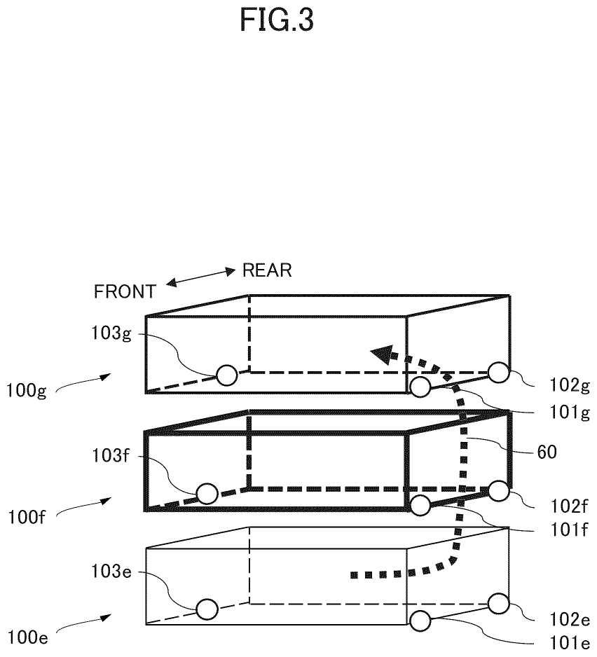

Next, with reference to FIGS. 1 and 2A to 2C, supporting configurations of the supply, imaging, and discharging blocks 110, 120, and 130 will be described using FIGS. 3 to 5C. In this embodiment, as illustrated in FIG. 3, the imaging block 120 is supported at three portions (101f, 102f, 103f) with respect to the supply frame 100e through the imaging frame 100f. The discharging block 130 is supported at three portions (101g, 102g, 103g) with respect to the imaging frame 100f through the discharging frame 100g. In addition, the supply block 110 is supported at three portions (101e, 102e, 103e) with respect to the installation surface such as the floor or desk through the supply frame 100e. To be noted, while not illustrated, three supporting portions that protrude downward are formed in each of the discharging, imaging, and supply frames 100g, 100f, and 100e, and these supporting portions provide support at three portions (101, 102, 103).

Incidentally, in a case where the apparatus body 1A can be divided into the supply, imaging, and discharging blocks 110, 120, and 130, if these supply, imaging, and discharging blocks 110, 120, and 130 are not supported via three portions, issues concerning the positional accuracy of the units and components mounted on the apparatus body 1A may emerge. Hereinafter, two issues will be specifically illustrated with examples.

A first issue is to ensure the flatness of the intermediate transfer belt 21. Since the intermediate transfer belt 21 is moved in a state of being stretched over the plurality of rollers (22, 23, 24), if the flatness of the intermediate transfer belt 21 fails to be maintained at equal to or more than a certain level, due to a difference in frictional resistance among the intermediate transfer belt 21 and the rollers (22, 23, 24), distortion will occur in the intermediate transfer belt 21, and transfer defects may be caused. In addition, since, due to the difference in the frictional resistance, a movement force in a rotational axis direction is generated in the intermediate transfer belt 21 at the drive roller 23, a regulation member to regulate so called “belt drift” where the intermediate transfer belt 21 shifts toward one end of the drive roller 23 or an alignment mechanism (also called as a steering mechanism) to correct the “belt drift” is disposed. However, if the movement force of the intermediate transfer belt 21 is too large, it is difficult to return the intermediate transfer belt 21 to its predetermined position in the rotational axis direction, and there is a risk that failures such as tearing of the intermediate transfer belt 21 could occur.

One of the factors contributing to inability to maintain the flatness of the intermediate transfer belt 21 is the distortion of the apparatus body 1A caused by the unevenness of the installation surface on which the image forming apparatus 1 is installed. In a case of supporting via four portions, there is a possibility that one portion of the four portions may not make contact with the installation surface due to an effect of the unevenness of the installation surface. At this time, there is a possibility that a load applied to the one portion without contact may cause the deformation of the frame. The deformation of the frame consequently results in a reduction in the positional accuracy of the units and components mounted on the frame.

Therefore, in the image forming apparatus of this embodiment, the apparatus body 1A is supported via the three portions, and, thereby the effect of the unevenness of the installation surface is suppressed, and. above the supporting portions, a relative position of each unit assembled into the apparatus body frame is ensured through the rigidity of the apparatus body frame. In more particular, by supporting the supply frame body 100e on the installation surface via the three portions (101e, 102e, 103e), the effect of the unevenness of the installation surface on the supply frame 100e is suppressed.

In addition, in this embodiment, a configuration in which the imaging frame 100f (and the discharging frame 100g) can be divided with respect to the supply frame 100e is adopted. Therefore, additionally, it is necessary to consider the distortion of the imaging frame 100f. As a solution with respect to the distortion of the imaging frame 100f, for example, a four-portion supporting configuration in which the supply and imaging frames 100e and 100f are secured near their four corners can be considered. By securing the frames near the four corners, through the rigidity of the supply and imaging frames 100e and 100f, the relative position of each unit assembled into the frames can be ensured.

However, in a case where the four-portion supporting configuration is adopted to the supply and imaging frames 100e and 100f, the supply and imaging frames 100e and 100f are susceptible to the effects of the installation surface of the supply frame 100e and component tolerances of the supporting portions of the imaging frame 100f. The required precision for the flatness of the intermediate transfer belt 21 is high, and the effects of such component tolerances cannot be ignored. Therefore, there is a room for further improvement in the four-portion supporting configuration described above.

Therefore, in this embodiment, as illustrated in FIG. 3, a three-portion supporting configuration in which the imaging frame 100f is supported with respect to the supply frame 100e via the three portions (101f, 102f, 103f) is adopted. The imaging frame 100f is supported with respect to the supply frame 100e via the first supporting portions 101f, the second supporting portions 102f, and the third supporting portion 103f. By supporting the imaging frame 100f via the three portions ((101f, 102f, 103f), it is possible to suppress the effect of the unevenness of the installation surface, the effect of the distortion of imaging frame 100f, and the effects of the component tolerances. To be noted, the supply frame 100e is supported with respect to the installation surface via the three supporting portions: a fourth supporting portion 101e, a fifth supporting portion 102e, and a sixth supporting portion 103e. In addition, the discharging frame 100g is supported with respect to the imaging frame 100f via the three supporting portions: a seventh supporting portion 101g, an eighth supporting portion 102g, and a ninth supporting portion 103g.

A second issue is an alignment assurance of roller pairs, which nip and convey the recording material S in the supply, imaging, and discharging conveyance paths 610, 620, and 630 (refer to FIG. 1), which are divided. Here, the alignment assurance refers to ensuring a state in which rotational axes are not misaligned among the roller pairs. When the rotational axes are misaligned among the roller pairs, a conveyance distance and the sliding resistance of the recording material S may vary, and there is a risk that the recording material S may be skewed. This can result in factors that degrade image position quality with respect to deliverables, referred to as geometric characteristics such as a left-edge margin. The misalignment among the roller pairs in the rotational axis direction may occur due to positional deviations in the lateral and vertical directions among the frames.

In this embodiment, as the solution to the first issue, the three-portion supporting configuration is adopted. While, at the supporting portions, it is possible to regulate positions in the vertical, front-to-rear, and lateral directions, at non-supporting portions, it is necessary to maintain degrees of freedom in the vertical and lateral positions to ensure the target flatness of the intermediate transfer belt 21. Therefore, as illustrated in FIG. 3, in each block, two portions (101, 102) among the three portions are arranged along the front-to-rear direction on a side of the conveyance path 60 (conveyance path side). In particular, when the imaging block 120 is viewed from above, the first and second supporting portions 101f and 102f of the imaging frame 100f are positioned further to a side of the imaging conveyance path 620 (refer to FIG. 1) than the center of the imaging block 120 is. When the supply block 110 is viewed from above, the fourth and fifth supporting portions 101e and 102e of the supply frame 100e are positioned further to a side of the supply conveyance path 610 (refer to FIG. 1) than the center of the supply block 110 is. In addition, when the discharging block 130 is viewed from above, the seventh and eighth supporting portions 101g and 102g of the discharging frame 100g are positioned further to a side of the discharging conveyance path 630 (refer to FIG. 1) than the center of the discharging block 130 is.

As described above, by arranging two (101, 102) of the three supporting portions on the side of the conveyance path 60 of each block in the front-to-rear direction, the positional relationship in the vertical direction can be ensured. Thereby, in the vertical conveyance method by which the recording material S is conveyed from below to above, even when the apparatus body 1A is configured to be divided into the plurality of blocks (110, 120, 130), it is possible to suppress the distortion in a series of the conveyance path 60 (vertical conveyance path) in the apparatus body 1A. Therefore, it is possible to suppress the occurrence of the deviations (alignment errors) in the rotational axis direction among the roller pairs that convey the recording material S.

The supply, imaging, and discharging frames 100e, 100f, and 100g include high strength struts (114ea, 114eb, 114fa, 114fb, 1144ga) and the reinforcement members (1152, 1151, 1150) (refer to FIGS. 2A to 2C). Therefore, the first supporting portion 101f of the imaging frame 100f is arranged on the right front strut 114fa, and the second supporting portion 102f of the imaging frame 100f is arranged on the reinforcement member 1151 on the right side of the rear-side plate 115f. The fourth supporting portion 101e of the supply frame 100e is arranged on the right front strut 114ea, and the fifth supporting portion 102e of the supply frame body 100e is arranged on the reinforcement member 1152 on the right side of the rear-side plate 115e. In addition, the seventh supporting portion 101g of the discharging frame 100g is arranged on the right front strut 114ga, and the eighth supporting portion 102g of the discharging frame 100g is arranged on the reinforcement member 1150 on the right side of the rear-side plate 115g. When the image forming apparatus 1 is viewed from above, it is preferred that the two supporting portions (101, 102) are respectively arranged to overlap the seventh, first, and fourth supporting portions 101g, 101f, and 101e and overlap the eighth, second, and fifth supporting portions 102g, 102f, and 102e. As described above, since the two supporting portions (101, 102) on the side of the conveyance path 60 of each block are arranged on the high strength struts and reinforcement members, the strength of supporting surfaces (seating surfaces) that support the two supporting portions (101, 102) is ensured by these struts and reinforcement members.

On the other hand, as illustrated in FIG. 3, remaining one supporting portion (103) of the three supporting portions is arranged on the opposite side across the conveyance path 60 in the lateral direction. In particular, when the imaging block 120 is viewed from above, the third supporting portion 103f of the imaging frame 100f is arranged on the left lower stay 113fc (refer to FIG. 2B) that is on a side further opposite to the imaging conveyance path 620 (refer to FIG. 1) than the center of the imaging block 120 is. When the supply block 110 is viewed from above, the sixth supporting portion 103e of the supply frame 100e is arranged on the left lower stay 113ec (refer to FIG. 2C) that is on a side further opposite to the supply conveyance path 610 (refer to FIG. 1) than the center of the supply block 110 is. In addition, the ninth supporting portion 103g of the discharging frame 100g is arranged on the left stay 113gc (refer to FIG. 2A) that is on a side further opposite to the discharging conveyance path 630 than the center of the discharging block 130 is.

As described above, the third supporting portion 103f of the imaging frame 100f and the ninth supporting portion 103g of the discharging frame 100g are respectively supported by the left upper stays 113ef and 113ff. Therefore, in comparison with the two supporting portions (101, 102) arranged on the strut or the reinforcement member, the supporting surface (seating surface) is susceptible to deflection. In particular, since both the imaging and discharging blocks 120 and 130 exert loads on the lowermost supply frame 100e, there is a high probability that the left upper stay 113ef may bend. When the left upper stay 113ef bends, it becomes difficult to resolve the issue described above.

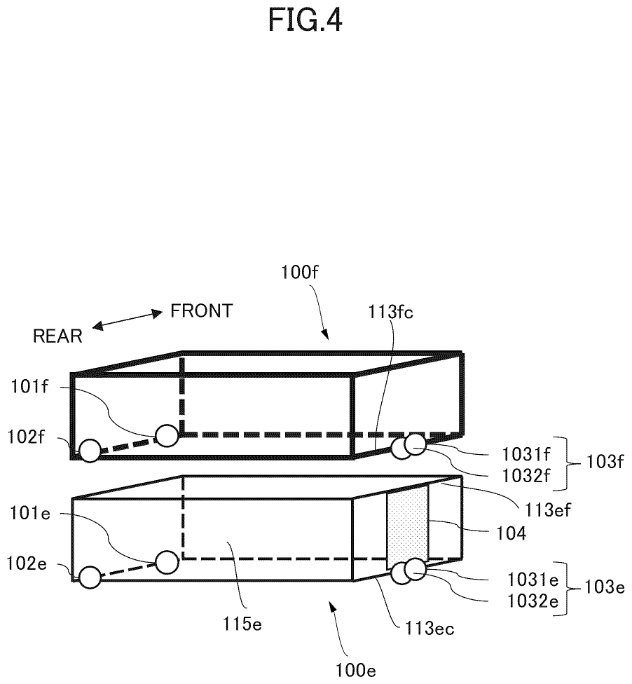

Therefore, in this embodiment, as illustrated in FIG. 4, in the supply frame 100e, a connecting strut 104 is disposed to connect the left upper stay 113ef, serving as a second stay, and the left lower stay 113ec, serving as a first stay. The left upper stay 113ef and the left lower stay 113ec extend from the rear-side plate 115e and extends in a direction perpendicularly to the vertical direction. When viewed from above, the third supporting portion 103f of the imaging frame 100f is arranged in a position overlapping the connecting strut 104. In addition, when viewed from above, the supporting portion 103e of the supply frame 100e is also arranged in a position overlapping the connecting strut 104. As described above, the connecting strut 104 is arranged in the position overlapping the supporting portion 103e of the supply frame 100e and the supporting portion 103f of the imaging frame 100f. In this way, after ensuring the strength and rigidity by the connecting strut 104, by arranging the supporting portion 103f of the imaging frame 100f on the connecting strut 104, even when the loads from both the imaging and discharge blocks 120 and 130 are applied, the left upper stay 113ef is prevented from bending.

To be noted, as illustrated in FIG. 4, for the third supporting portion 103f of the imaging frame 100f and the sixth supporting portion 103e of the supply frame 100e, in addition to cases where one contact portion, such as a projection, which comes into contact with the supporting surface, is provided at a single location, there are also cases where equal to or more than two contact portions (1031f and 1032f, 1031e and 1032e) are provided at a single location. For example, by reducing a distance between the two contact portions, a single supporting portion can be configured. However, in the configuration having the three supporting portions, if any one of the supporting portions has two contact portions and the distance between the contact portions is substantial, it eventually results in a configuration that is not different from the four-portion supporting configuration. Therefore, in such a case, the distance between the two contact portions is set to be “equal to or less than 20%” of the length of the left lower stays (113fc, 113ec) on which the supporting portions are arranged. For example, in a case where the length of one side of the left lower stay (113fc, 113ec) is 600 millimeters (mm), the distance between the two contact portions is equal to or less than 120 mm. In this case, the two contact portions (1031f and 1032f, 1031e and 1032e) are each arranged in the position overlapping the connecting strut 104. To be noted, it is preferable that the two contact portions described above are arranged to align along the front-to-rear direction. In addition, while a lower limit distance between the two contact portions is not specifically restricted, “equal to or more than 5%” of the length of the left lower stay (113fc, 113ec) on which the contact portions are disposed is preferable.

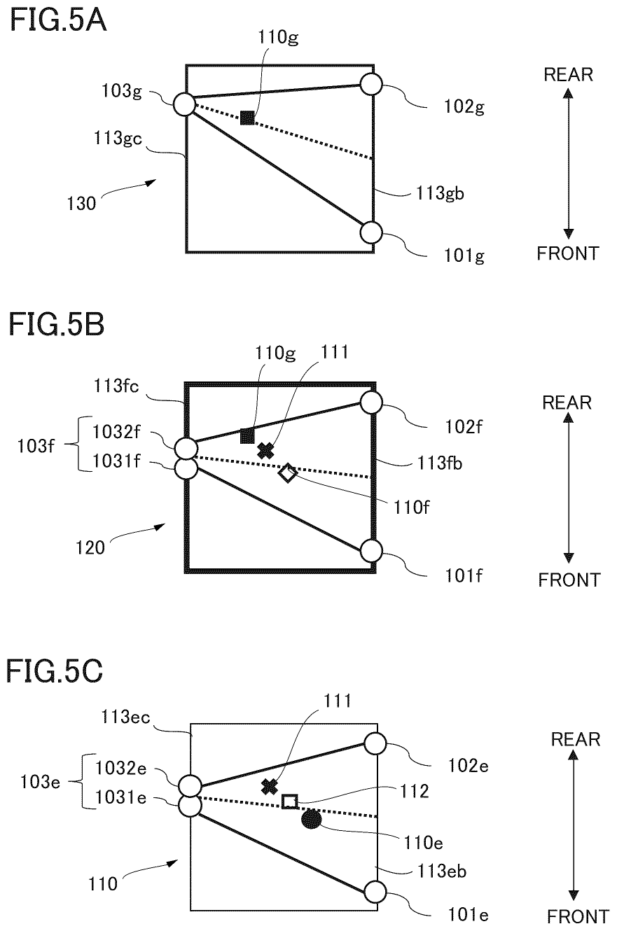

Further, positional relationships among the three supporting portions (101, 102, 103) described above will be described using FIGS. 5A to 5C. FIG. 5A is a schematic diagram illustrating the positional relationships among the three supporting portions (101g, 102g, 103g) in the discharging block 130 when viewed from above. FIG. 5B is a schematic diagram illustrating the positional relationships among the three supporting portions (101f, 102f, 103f) in the imaging block 120 when viewed from above. FIG. 5C is a schematic diagram illustrating the positional relationships among the three supporting portions (101e, 102e, 103e) in the supply block 130 when viewed from above.

In the image forming apparatus 1, to improve usability during maintenance or replacement, a configuration that allows the user to insert and remove components such as the photosensitive drums 11Y to 11K and the developing apparatuses 14Y to 14K from the front side with respect to the apparatus body 1A is adopted. Then, on the rear side (back side) of the apparatus body 1A, a power unit for electricity supply and drive units such as a motor are arranged. In addition, the document reading unit 30 (refer to FIG. 1) is arranged on top of the apparatus body 1A, and, as described above, the document conveyance unit of the document reading unit 30 can be opened and closed to the front side (front face side). In such an image forming apparatus 1 of the vertical conveyance method, when the apparatus body 1A is configured to be divided into the aforementioned blocks (110, 120, 130), the center of gravity of the discharging and imaging blocks 130 and 120 shifts toward the rear.

In a case of adopting the three supporting portions described above, when each center of gravity (110g, 110f, 110e, refer to FIGS. 5A, 5B, and 5C) of each individual block (110, 120, 130) falls outside of a triangular area formed by the three supporting portions (101, 102, 103), the three-portion supporting by the three supporting portions (101, 102, 103) cannot be preserved with respect to a block whose center of gravity is outside of the triangular area. As a result, since the apparatus body 1A, which stacks the blocks, is installed in a deformed state, it becomes difficult to ensure the flatness of the intermediate transfer belt 21 described above and to realize the alignment assurance of the roller pairs. Therefore, in each block (110, 120, 130), using the two supporting portions (101, 102) arranged on the side of the conveyance path 60 as a reference, it is necessary to determine the position of the remaining portion (103) such that the center of gravity (110g, 110f, 110e) does not fall outside of the triangular area.

In this embodiment, as illustrated in FIG. 5A, in the discharging block 130, the supporting portion 103g is arranged on the left stay 113gc such that the center of gravity 110g, including the document reading unit 30, is positioned on a center line, indicated by a dotted line, of the triangular area. To be noted, as described above, the seventh supporting portion 101g of the discharging frame 100g is arranged on the right front strut 114ga, and the eighth supporting portion 102g of the discharging frame 100g is arranged on the reinforcement member 1150 on the right side of the rear-side plate 115g.

As illustrated in FIG. 5B, in the imaging block 120, the supporting portion 103f is arranged on the left lower stay 113fc such that the center of gravity 110g of the discharging block 130, the center of gravity 110f of the imaging block 120 alone, and the first composite center of gravity 111, which is formed by combining these center of gravity 110g and center of gravity 110f, are positioned inside of the triangular area. The first composite center of gravity 111 is positioned on a linear line connecting the center of gravity 110g of the discharging block 130 and the center of gravity of the imaging block 120 alone. To be noted, as described above, the first supporting portion 101f of the imaging frame 100f is arranged on the right front strut 114fa, and the second supporting portion 102f of the imaging frame 100f is arranged on the reinforcement member 1151 on the right side of the rear-side plate 115f.

As illustrated in FIG. 5C, in the support frame 100e, the supporting portion 103e is arranged on the left lower stay 113ec such that the center of gravity 110e of the support block 110 alone, the first composite center of gravity 111 described above, and a second composite center of gravity 112, which is formed by combining these center of gravity 110e and composite center of gravity 111, are positioned inside of the triangular area. The second composite center of gravity 112 is positioned on a linear line connecting the center of gravity 110g of the supply block 110 and the first composite center of gravity 111, and serves as the center of gravity of the entire apparatus body 1A. To be noted, as described above, the fourth supporting portion 101e of the supply frame 100e is arranged on the right front strut 114ea, and the fifth supporting portion 102e of the supply frame 100e is arranged on the reinforcement member 1152 on the right side of the rear-side plate 115e.

In this embodiment, the document reading unit 30 that shifts the center of gravity toward the rear, is disposed on top of the discharging block 130. Therefore, in the discharging frame 100g, on which the document reading unit 30 exerts a load, the supporting portion 103g is arranged further rearward than the supporting portion 103f of the imaging frame 100f and the supporting portion 103e of the supply frame 100e is. On the other hand, the supporting portion 103f of the imaging frame 100f is arranged further forward than the supporting portion 103g of the discharging frame 100g in the front-to-rear direction is. Further, the supporting portion 103e of the supply frame 100e is arranged further forward than the supporting portion 103f of the imaging frame 100f in the front-to-rear direction is. This is because, by shifting the center of gravity of the discharging block 130, on which the document reading unit is disposed, toward the rear and by placing the center of gravity of the supply frame 100e toward the front, the apparatus body 1A constituted by the discharging, imaging, and supply blocks 130, 120, and 110 achieves stability.

As described above, the image forming apparatus 1 of this embodiment includes the three structures: the supply, imaging, and discharging blocks 110, 120, and 130 which are separable. These supply, imaging, and discharging blocks 110, 120, and 130 respectively include the supply, imaging, and discharging frames 100e, 100f, and 100g, and various units and components are mounted within each frame. While the apparatus body 1A of the image forming apparatus 1 is assembled by stacking these supply, imaging, and discharging blocks 110, 120, and 130, the imaging block 120 is supported via the three supporting portions with respect to the supply block 110. In addition, the discharging block 130 is supported via the three supporting portions with respect to the imaging block 120. By supporting each block via the three supporting portions as described above, the apparatus body 1A becomes more resistant to being affected by the unevenness of the installation surface. Therefore, the flatness of the intermediate transfer belt 21 within the apparatus body 1A is ensured, and it is possible to suppress the occurrence of alignment errors among the roller pairs that convey the recording material S.

To be noted, to expand the functions of the image forming apparatus 1, sometimes, units that implement new functions (such as a second fixing unit) are added and mounted to the supply, imaging, and discharging frames 100e, 100f, and 100g. In such a case, the arrangement of the three supporting portions (101, 102, 103) described above is adjusted according to the centers of gravity of the supply, imaging, and discharging blocks 110, 120, and 130. For example, it is acceptable to configure such that, by detachably disposing the three supporting portions each forming the supporting portion at a plurality of positions on struts and stays, the positions of the supporting portions in each block are adjusted according to the center of gravity of a block to which units have been newly added.

### OTHER EMBODIMENT

To be noted, while, in this embodiment, the image forming apparatus 1 utilizes the intermediate transfer system in which the toner images of each color are secondarily transferred onto the recording material S after having been primarily transferred from the photosensitive drums 11Y to 11K onto the intermediate transfer belt 21, it is not limited to this. For example, the image forming apparatus may utilize a direct transfer system in which the recording material S is conveyed by a conveyance belt that forms a nip portion with photosensitive drums, the toner images on the photosensitive drums are directly transferred onto a sheet by applying voltage to a transfer roller arranged to face the photosensitive drums across the conveyance belt.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-030718, filed Feb. 29, 2024, which is hereby incorporated by reference herein in its entirety.

What is claimed is:

1. An image forming apparatus configured to form an image on a recording medium, the image forming apparatus comprising:
a first block including:
a first frame,
a transfer member configured to transfer the image onto the recording medium, and
a first conveyance path in which the recording medium is conveyed;
a second block including:
a second frame separably stacked on the first frame,
a second conveyance path in which the recording medium is conveyed from the first conveyance path, and
a discharging unit configured to discharge the recording medium conveyed through the second conveyance path to an outside;
three supporting portions for supporting the first block; and
three supporting portions for supporting the second block,
wherein the first block is supported via the three supporting portions for supporting the first block, and
wherein the second block is supported via the three supporting portions for supporting the second block with respect to the first block.

2. The image forming apparatus according to claim 1, further comprising:
a third block including:
a third frame separably arranged beneath the first frame,
a container configured to store the recording medium,
a supply unit configured to supply the recording medium from the container toward an inside of the first frame, and
a third conveyance path in which the recording medium is conveyed from the container toward the first conveyance path,
wherein the first block is supported via the three supporting portions for supporting the first block with respect to the third block.

3. The image forming apparatus according to claim 1,
wherein the three supporting portions for supporting the first block are a first supporting portion, a second supporting portion, and a third supporting portion, and
wherein, when the first block is viewed from above, among the first supporting portion, the second supporting portion, and the third supporting portion, the first supporting portion and the second supporting portion are positioned further to a side of the first conveyance path than a center of the first block is.

4. The image forming apparatus according to claim 3,
wherein, when the first block is viewed from above, the third supporting portion is positioned further to a side opposite to the first conveyance path than the center of the first block is.

5. The image forming apparatus according to claim 4,
wherein each of the first supporting portion, the second supporting portion, and the third supporting portion is composed of one contacting portion contacting with a supporting surface supporting the first block.

6. The image forming apparatus according to claim 4,
wherein each of the first supporting portion and the second supporting portion is composed of one contacting portion contacting with a supporting surface supporting the first block,
wherein the third supporting portion is composed of two contacting portions contacting with the supporting surface, and
wherein a distance between the two contacting portions of the third supporting portion is equal to or less than 20% of a length of a stay with the third supporting portion provided.

7. The image forming apparatus according to claim 2,
further comprising three supporting portions for supporting the third block,
wherein the three supporting portions for supporting the third block are a fourth supporting portion, a fifth supporting portion, and a sixth supporting portion for supporting the third block with respect to an installation surface, and
wherein, when the third block is viewed from above, among the fourth supporting portion, the fifth supporting portion, and the sixth supporting portion, the fourth supporting portion and the fifth supporting portion are positioned further to a side of the third conveyance path than a center of the third block is.

8. The image forming apparatus according to claim 7,
wherein, when the third block is viewed from above, the sixth supporting portion is positioned further to a side opposite to the third conveyance path than the center of the third block is.

9. The image forming apparatus according to claim 7,
wherein each of the fourth supporting portion, the fifth supporting portion, and the sixth supporting portion is composed of one contacting portion contacting with a supporting surface supporting the third block.

10. The image forming apparatus according to claim 7,
wherein each of the fourth supporting portion and the fifth supporting portion is composed of one contacting portion contacting with a supporting surface supporting the third bloc,
wherein the sixth supporting portion is composed of two contacting portions contacting with the supporting surface, and
wherein a distance between the two contacting portions of the sixth supporting portion is equal to or less than 20% of a length of a stay with the sixth supporting portion provided.

11. The image forming apparatus according to claim 2,
further comprising three supporting portions for supporting the third block,
wherein the three supporting portions of the first block are a first supporting portion, a second supporting portion, and a third supporting portion,
wherein, when the first block is viewed from above, among the first supporting portion, the second supporting portion, and the third supporting portion, the first supporting portion and the second supporting portion are positioned further to a side of the first conveyance path than a center of the first block is,
wherein the three supporting portions for supporting the third block are a fourth supporting portion, a fifth supporting portion, and a sixth supporting portion for supporting the third block with respect to an installation surface, and
wherein, when the third block is viewed from above, among the fourth supporting portion, the fifth supporting portion, and the sixth supporting portion, the fourth supporting portion and the fifth supporting portion are positioned further to a side of the third conveyance path than a center of the third block is,
wherein the third frame includes a side plate, a strut extending in a vertical direction, a first stay extending in a direction intersecting the vertical direction to connect the side plate and the strut, a second stay arranged above the first stay to connect the side plate and the strut, and a connecting strut extending from the first stay toward the second stay to connect the first stay and the second stay, and
wherein, when the image forming apparatus is viewed from above, the third supporting portion and the sixth supporting portion overlap the connecting strut.

12. The image forming apparatus according to claim 3,
wherein the three supporting portions for supporting the second block are a seventh supporting portion, an eighth supporting portion, and a ninth supporting portion, and
wherein, when the second block is viewed from above, among the seventh supporting portion, the eighth supporting portion, and the ninth supporting portion, the seventh supporting portion and the eighth supporting portion are positioned further to a side of the second conveyance path than a center of the second block is.

13. The image forming apparatus according to claim 12,
wherein, when the second block is viewed from above, the ninth supporting portion is positioned further to a side opposite to the second conveyance path than the center of the second block is.

14. The image forming apparatus according to claim 12,
wherein, when the image forming apparatus is viewed from above, the first supporting portion and the seventh supporting portion overlap each other, and
wherein, when the image forming apparatus is viewed from above, the second supporting portion and the eighth supporting portion overlap each other.

15. The image forming apparatus according to claim 12,
wherein, when the image forming apparatus is viewed from above, the first supporting portion, the second supporting portion, and the third supporting portion are arranged in the first block such that a center of gravity of the first block, a center of gravity of the second block, and a first composite center of gravity, that is formed by combining the center of gravity of the first block and the center of gravity of the second block, are positioned inside of an area formed by connecting the first supporting portion, the second supporting portion, and the third supporting portion.

16. The image forming apparatus according to claim 11,
wherein, when the image forming apparatus is viewed from above, the fourth supporting portion, the fifth supporting portion, and the sixth supporting portion are arranged in the third block such that a center of gravity of the third block, a first composite center of gravity that is formed by combining a center of gravity of the first block and a center of gravity of the second block, and a second composite center of gravity that is formed by combining the center of gravity of the third block and the first composite center of gravity are positioned inside of an area formed by connecting the fourth supporting portion, the fifth supporting portion, and the sixth supporting portion.

17. The image forming apparatus according to claim 1, further comprising:
a photosensitive member;
a charge unit configured to charge the photosensitive member;
an exposing unit configured to form an electrostatic latent image by exposing the photosensitive member that has been charged;
a developing unit configured to develop the electrostatic latent image on the photosensitive member into a toner image; and
a second transfer member configured to form a transfer portion with the transfer member to transfer the toner image from the transfer member onto the recording medium,
wherein the transfer member includes an intermediate transfer member onto which the toner image formed on the photosensitive member is primarily transferred, and
wherein the second transfer member is configured to secondarily transfer the toner image from the intermediate transfer member onto the recording medium.
